(19) United States
(12) Patent Application Publication
(10) Pub. No.: US 2019/0023912 A1
(43) Pub. Date: Jan. 24, 2019

(54) Coating Comprising A Temperature Sensor

(71) Applicant: Siemens Aktiengesellschaft, Muenchen (DE)

(72) Inventors: Wolfgang Rossner, Holzkirchen (DE); Niels Van der Laag, München (DE)

(73) Assignee: Siemens Aktiengesellschaft, Muenchen (DE)

(21) Appl. No.: 16/080,791

(22) PCT Filed: Feb. 27, 2017
(86) PCT No.: PCT/EP2017/054445

§ 371 Date: Aug. 29, 2018

(30) Foreign Application Priority Data
Feb. 29, 2016 (DE) 10 2016 203 246.1

(51) Int. Cl. C09D 5/26; C09D 1/00; C09D 5/22; G01K 11/20; G01K 3/04; C08K 3/20

(52) U.S. Cl. CPC C09D 5/26; C09D 1/00; C08K 3/20; G01K 11/20; G01K 3/04; C09D 5/22

(57) ABSTRACT

Various embodiments may include a coating for a component which is exposed to hot gases, for example a boiler, a fuel cell, a melting furnace, an engine, a power unit, a gas turbine vane and/or a gas turbine blade. For example, a coating may include: a ceramic material including particles in a ceramic matrix, the particles comprising luminescing europium and/or samarium 2+ ions. The luminescing ions transform into a species comprising europium and/or samarium 3+ ions. The particles and the species luminesce differently in a kinetically single-stage reaction, resulting in a direct relationship between the luminescence and the temperature history of a component equipped with the coating.

### CROSS-REFERENCE TO RELATED APPLICATIONS

This application is a U.S. National Stage Application of International Application No. PCT/EP2017/054445 filed Feb. 27, 2017, which designates the United States of America, and claims priority to DE Application No. 10 2016 203 246.1 filed Feb. 29, 2016, the contents of which are hereby incorporated by reference in their entirety.

### TECHNICAL FIELD

The present disclosure relates to temperature sensors. Various embodiments may include a coating for a component which is exposed to hot gases, for example a boiler, a fuel cell, a melting furnace, an engine, a power unit, a gas turbine vane and/or a gas turbine blade.

### BACKGROUND

Methods by means of which the surface temperature of components subjected to extremely high temperatures, e.g. a gas turbine blade and/or a gas turbine vane, can be measured during operation are known. However, these surface methods or sensors generally cannot be read during operation.

A method for determining the temperature history of such components is known from U.S. Pat. No. 8,746,969 B2. In this method, the transformation of amorphous starting materials into particular crystallization stages establishes the temperatures to which these starting materials have been exposed. However, the temperature ranges which can be measured remain below a limit of about 1000° C. and the measured values are imprecise because crystallization is a multistage kinetic process which does not have a simple linear dependence of the modification of the compound on the temperature. A precise indication of the temperature is difficult, particularly in the temperature ranges in which a modification takes place.

There is therefore still a need to make available a material for coating components subjected to extremely high temperatures by means of which the temperature history of the component becomes comprehensible, in the most favorable case during operation. Such a material must satisfy a demanding property profile, in particular insofar as stability at high temperatures, compatibility with conventional TBCs (thermal barrier coatings) and simplicity of the relationship between temperature and discernible and/or measurable properties of the material are concerned.

### SUMMARY

The teachings of the present disclosure may be embodied in a material which satisfies the property profile required above and in particular one which can be incorporated into existing thermal barrier coatings (TBC) or thermal barrier coatings to be produced on components such as a boiler, fuel cell, melting furnace, engine, power unit, gas turbine vane and/or gas turbine blade. For example, some embodiments may include a thermally stressable coating composed of a ceramic material, characterized in that it comprises particles having, in a ceramic matrix, a concentration of luminescing europium and/or samarium 2+ ions, where the transformation of these europium and/or samarium 2+ ions into a species which comprises europium and/or samarium 3+ ions and luminesces differently occurs in a kinetically single-stage reaction, so that a direct relationship between the type of luminescence, i.e. the concentration of europium and/or samarium 2+ ions in the matrix, and the temperature history of a component equipped with the coating can be produced and, for example, be depicted in graph form.

In some embodiments, the europium and/or samarium 2+ ions are present at least partly in a crystal lattice as substitutional occupation of a cation lattice site.

In some embodiments, the particles containing europium and/or samarium 2+ ions are present in an amount of more than 1 mol % in the ceramic coating.

In some embodiments, the matrix is at least partly a coating material for thermal barrier coatings (TBC), in particular a matrix composed of an yttrium oxide, for example Y₂Al₅O₁₂, and/or another oxidic ceramic material.

In some embodiments, an yttrium-aluminum garnet oxide is present as matrix.

In some embodiments, the melting point of the luminescing particles is above 1000° C.

In some embodiments, the luminescing particles are embedded in the form of spherical particles in the coating.

As another example, some embodiments may include a component of a boiler, a fuel cell, a melting furnace, an engine, a power unit, a gas turbine, for example a gas turbine vane and/or a gas turbine blade, having a coating as described above.

### DETAILED DESCRIPTION

The teachings of the present disclosure describe a thermally stressable coating composed of a ceramic material, characterized in that it comprises particles having, in a ceramic matrix, a concentration of luminescing europium and/or samarium 3+ ions, where the transformation of these europium and/or samarium 3+ ions into a species which comprises europium and/or samarium 2+ ions and luminesces differently occurs in a kinetically single-stage reaction, so that a direct relationship between the type of luminescence, i.e. the concentration of europium and/or samarium 3+ ions in the matrix, and the temperature history of a component equipped with the coating can be produced and, for example, be depicted in graph form.

In some embodiments, the europium and/or samarium 3+ ions are present in the ceramic matrix material of the particles as substitutional occupation of cation lattice sites.

In some embodiments, the coating comprises the particles containing europium and/or samarium 3+ ions in an amount of more than 1 mol %. In particular, the luminescing particles are present in an amount of more than 5 mol %, and particular preference is given to the luminescing particles being present in an amount of more than 10 mol % in the ceramic coating.

In some embodiments, the luminescing particles can be readily incorporated into the ceramic coating because the matrix material is compatible with and/or crystallographically similar or sometimes even identical to the material of the coating.

In some embodiments, the matrix is a coating material for thermal barrier coatings (TBC), in particular a material composed of an yttrium-aluminum oxide, for example Y₂Al₅O₁₂, or another oxidic ceramic material. Suitable TBCs are known, for example, from U.S. Pat. No. 8,685,545, EP1915639 and/or WO2007/020170. The luminescing Eu3+ and/or Sm3+ ions can be readily incorporated into a ceramic matrix since they can, due to their ionic radius, occupy cation sites in various ceramic lattice structures without bringing about disruption of the lattice structure.

The europium and/or samarium 2+ and/or 3+ ions have already been tested successfully in an yttrium oxide matrix, for example in an yttrium-aluminum oxide matrix. For this purpose, particles having a matrix composed of an yttrium oxide-containing ceramic having, for example, a melting point above 1300° C., a polyhedral morphology and/or a particle size in the range from 2 to 50 μm were used. The europium and/or samarium 3+ ions are built into the host lattice without destroying the morphology.

In some embodiments, the luminescing particles are used at least partly in the form of spherical particles. Particularly when the particles are employed in a gas turbine blade or gas turbine vane coating, the oxidation of the europium and/or samarium 2+ ions to the europium and/or samarium 3+ ions, which luminesce significantly differently, is promoted by the hot and oxygen-containing vapor.

In some embodiments, the decay time of one luminescing species depends only on a single reaction by means of which the luminescing cation concerned is converted into its other luminescing species. This is the simple oxidation which converts Eu²⁺ into Eu³⁺ with otherwise the same chemical environment and the same lattice structure. The luminescence changes significantly as a result and the temperature can be detected without problems. In particular, the temperature can be followed by means of a spectroscopic method and/or with the aid of a reference table, so that the temperature history can be concluded directly from the concentration and type of the luminescing species.

The incorporation of the luminescing particles into the coating can be effected during production and/or else as after-treatment, for example by spraying on, coating, painting, etc., in a suitable binder system.

The teachings of the present disclosure relate to a coating for a component which is exposed to hot gases, for example a boiler, a fuel cell, a melting furnace, an engine, a power unit, a gas turbine vane and/or a gas turbine blade. The coating is characterized in that it has a temperature sensor in the form of a light-emitting coating whose light emission depends on the temperatures to which the coating is or has been subjected.

What is claimed is:

1. A coating comprising:
a ceramic material including
particles in a ceramic matrix;
the particles comprising luminescing europium and/or samarium 2+ ions;
wherein the luminescing ions transform into a species comprising europium and/or samarium 3+ ions; and
the particles and the species luminesce differently in a kinetically single-stage reaction, resulting in a direct relationship between the luminescence and the temperature history of a component equipped with the coating.

2. The coating as claimed in claim 1, wherein the europium and/or samarium 2+ ions are present at least partly in a crystal lattice as substitutional occupation of a cation lattice site.

3. The coating as claimed in claim 1, wherein the ceramic coating comprises more than 1 mol % of the particles containing europium and/or samarium 2+ ions.

4. The coating as claimed in claim 1, wherein the matrix comprises a coating material for thermal barrier coatings (TBC).

5. The coating as claimed in claim 1, wherein the matrix comprises an yttrium-aluminum garnet oxide.

6. The coating as claimed in claim 1, wherein the luminescing particles have a melting point above 1000° C.

7. The coating as claimed in claim 1, wherein the luminescing particles comprises spherical particles embedded in the coating.

8. (canceled)

9. The coating as claimed in claim 1, wherein the matrix comprises a matrix composed of an yttrium oxide.

10. The coating as claimed in claim 1, wherein the matrix comprises a matrix composed of Y₂Al₅O₁₂.
